(19) United States
(12) Patent Application Publication
(10) Pub. No.: US 2006/0121890 A1
(43) Pub. Date: Jun. 8, 2006

(54) System and method for controlling receiving mode of mobile terminal

(75) Inventor: Myung-Joo Chae, Sungnam (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/289,839

(22) Filed: Nov. 29, 2005

(30) Foreign Application Priority Data
Nov. 29, 2004 (KR) 98802/2004

(51) Int. Cl. H04M 3/42

(52) U.S. Cl. 455/415; 455/461

(57) ABSTRACT

A system for controlling a receiving mode of a mobile terminal includes: a transmission terminal for inputting a phone number and an identifier and outputting a transmission call based on the phone number and the identifier; a base station for outputting a call event based on the phone number and the identifier detected from the outputted transmission call; and a receiving terminal for executing a predetermined receiving mode according to the outputted call event.

### CROSS REFERENCE TO RELATED APPLICATION

Pursuant to 35 U.S.C. § 119(a), this application claims the benefit of earlier filing date and right of priority to Korean Application No. 10-2004-0098802, filed Nov. 29, 2004, the contents of which are hereby incorporated by reference herein in their entirety.

### BACKGROUND OF THE INVENTION

1. Field of the Invention

The present invention relates to a mobile terminal and, more particularly, to a system and method for controlling a receiving mode of a mobile terminal capable of accurately detecting a position of a mobile terminal.

2. Description of the Related Art

In general, a mobile terminal is a device for allowing a user to wirelessly page and be connected with another device or user for communication any time anywhere through the switching control of an MSC (Mobile Switching Center) while moving in a service area handled by a base station (BS). With the mobile terminal, data communication using symbols, numbers and characters and multimedia communication including images, as well as voice communications can be performed.

Most mobile terminals set a receiving mode to inform the user about call reception, and the receiving mode can be divided into a sound mode, a vibration mode and a mute mode. When the mobile terminal is set in the sound mode, a call reception is indicated by sounds. If the mobile terminal is set in the vibration mode, a call reception is indicated with vibrations. Meanwhile, if the mobile terminal is set in the mute mode, only a light (LED) on the mobile terminal blinks to inform the user about a received call.

Thus, when the mobile terminal receives a call event from a base station, it can inform the user that a call has been received according to the receiving mode previously set by the user. For example, if the user has misplaced his mobile terminal or cannot locate it, he can call his mobile terminal which may then ring or output sounds if it has been set in the sound mode, and the location of the mobile terminal may be determined.

However, if the mobile terminal is set in the vibration mode or the mute mode, the position of the mobile terminal may be difficult to determine.

As mentioned above, the related art mobile terminal has problems in that the receiving mode previously set by the user may not be desirable in certain situations.

### BRIEF DESCRIPTION OF THE INVENTION

Therefore, an object of the present invention is to provide a system and method for controlling a receiving mode of a mobile terminal capable of detecting a position of the mobile terminal. This is achieved by adding a certain identifier to a phone number and then transmitting it to the mobile terminal.

To achieve at least the above objects in whole or in parts, there is provided a system for controlling a receiving mode of a mobile terminal including: a transmission terminal for inputting a phone number and an identifier and outputting a transmission call based on the phone number and the identifier; a base station for outputting a call event based on the phone number and the identifier detected from the outputted transmission call; and a receiving terminal for executing a predetermined receiving mode according to the outputted call event.

To achieve at least the above objects in whole or in parts, there is provided a mobile terminal for controlling a receiving mode, the mobile terminal including: a controller for generating transmission call based on a phone number and an identifier inputted by user; and a transmitting unit for transmitting the generated transmission call.

To achieve at least the above objects in whole or in parts, there is provided a mobile terminal for controlling a receiving mode, the mobile terminal including: a receiving unit for receiving a call event outputted from a base station; and a controller for executing a predetermined receiving mode according to the received call event.

To achieve at least these advantages in whole or in parts, there is further provided a method for controlling a receiving mode of a mobile terminal including: inputting a phone number and an identifier and transmitting a transmission call based on the phone number and the identifier; detecting the phone number and the identifier from the transmitted transmission call; generating a call event according to the detection result; checking whether the generated call event is a search call event; and executing a pre-set receiving mode according to the checking result.

To achieve at least the above objects in whole or in parts, there is provided a mobile terminal comprising: a transceiver to send and receive signals via a mobile communication network; an output unit to provide audible, visual, and/or tactile outputs upon receiving an incoming communication; and a processor cooperating with the transceiver and the output unit to perform the steps of, receiving a request to perform a phone location search feature, the request being included within the incoming communication, and providing an audible output such that the location of the mobile terminal can be determined by the user upon receiving the request to perform the phone location search feature.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a system for controlling a receiving mode of a mobile terminal in accordance with an exemplary embodiment of the present invention; and

FIG. 2 is a flow chart of a method for controlling a receiving mode of a mobile terminal in accordance with an exemplary embodiment of the present invention.

### DETAILED DESCRIPTION OF THE PREFERRED EMBODIMENTS

A system and method for controlling a receiving mode of a mobile terminal that allows accurate detection of the mobile terminal's position (location) by adding a certain identifier to a phone number of the mobile terminal and transmitting it, in accordance with an exemplary embodiment of the present invention will now be described with reference to the accompanying drawings.

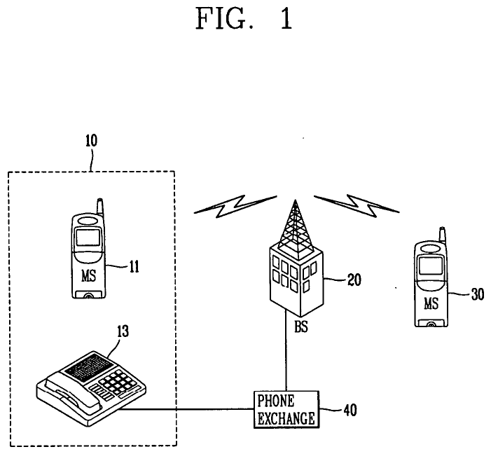

FIG. 1 illustrates a system for controlling a receiving mode of a mobile terminal in accordance with an exemplary embodiment of the present invention.

As shown in FIG. 1, a system for controlling a receiving mode of a mobile terminal in accordance with the present invention may include: a transmission terminal 10 for inputting a phone number and an identifier and outputting a transmission call based on the phone number and the identifier; a base station 20 for outputting a call event based on the phone number and the identifier detected from the outputted transmission call; and a receiving terminal 30 for executing a pre-set receiving mode according to the outputted call event.

The transmission terminal 10 may include a mobile terminal 11 for performing wireless communications and a general fixed line phone 13 for performing wired communications.

In case that the transmission terminal 10 is the general fixed line phone 13, the general fixed line phone 13 outputs the transmission call to a phone exchange 40 and the phone exchange 40 transmits the outputted transmission call to a base station 30 corresponding to the phone number.

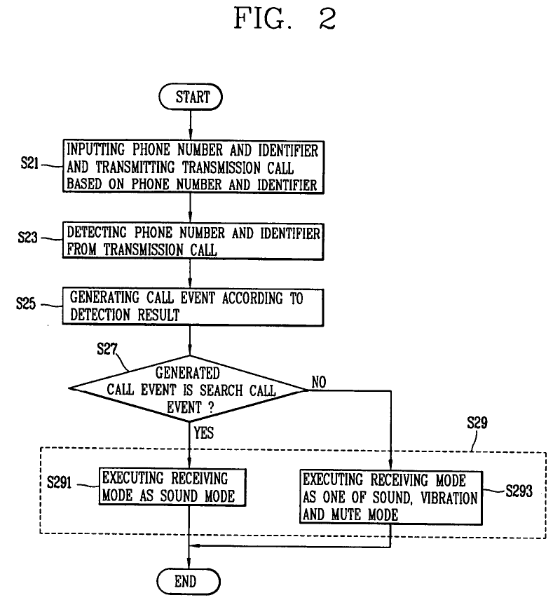

An exemplary method for controlling a receiving mode of a mobile terminal will now be described with reference to FIG. 2.

FIG. 2 is a flow chart of an exemplary method for controlling a receiving mode of a mobile terminal in accordance with an exemplary embodiment of the present invention.

As shown in FIG. 2, a method for controlling a receiving mode of a mobile terminal may include: inputting a phone number and an identifier and transmitting a transmission call based on the phone number and the identifier (step S21); detecting the phone number and the identifier from the transmitted transmission call (step S23); generating a call event according to the detection result (step S25); checking whether the generated call event is a search call event (step S27); and executing a certain receiving mode according to the checking result (step S29).

An exemplary method for controlling a receiving mode of a mobile terminal in accordance with the present invention will be described in detail as follows.

First, the user generates a transmission call by inputting a phone number and an identifier to the transmission terminal 10 (step S21). In this case, the transmission terminal 10 must generate the transmission call upon inputting the phone number and the identifier, and the identifier can be made by combining a symbol or a number with the phone number in various forms.

There can be several ways to generate the transmission call by adding the identifier to the phone number of the mobile terminal, including: (1) an identifier, for example, ‘#’ or ‘*’ can be added before, after or in the middle of the phone number, and (2) a menu for generating a transmission call, for example, “search of mobile terminal”, can be added to a menu of the transmission terminal.

The base station 20 detects the phone number and the identifier from the generated transmission call (step S23) and transmits a call event to the receiving terminal according to the detection result (step S25). Then, the receiving terminal 30 checks whether the transmitted call event is a search call event (step S27) and executes a certain receiving mode according to the checking result (step S29). Namely, when the base station detects the phone number and the identifier, it generates the search call event and transmits the generated search call event to the receiving terminal 30.

When the base station 20 does not detect the phone number and the identifier, it generates a general call event and transmits the generated general call event to the receiving terminal 30. Namely, the base station 20 determines that the generated transmission call is not for detecting a position of the mobile terminal.

Meanwhile, when the transmission terminal 10 is the general fixed line phone 13, a transmission call generated from the transmission terminal 10 is transmitted to the base station 20 through the phone exchange 40. Thus, in this case, the phone exchange 40 should be able to receive the phone number and the is identifier and transmit them as it is to the base station 20.

The base station 20 can generate the search call event in various ways: (1) an alert command, for example, ACP5553_ALERT_ORDER(0×0001), ACP553_ALERT_W_INFO_ORDER(0×0011), or the like, can be added to the general call event and (2) a SO (Service Option), for example, CAI_SO_VOICE_IS96A(0×0001) or CAI_SO_VOICE_EVRC(0×0003), or the like can be added to the general call event. The search call event can add various options that can indicate the search call as well as the alert command or the SO.

Thus, when the mobile terminal receives the search call event, no matter which mode (i.e., the sound mode, the vibration mode or the mute mode) the mobile terminal itself has been set, the user is informed of the received call in the sound mode unconditionally (step S291), so the user can accurately be notified of the mobile terminal's location. Herein, the certain receiving mode may be a sound mode which may be more effective compared to the vibration mode or the mute mode in allowing the user to locate his mobile terminal.

However, when the mobile terminal receives a general call event, it informs the user about the received call in the pre-set received mode, namely, in the sound mode, the vibration mode or the mute mode (step S293).

The present invention provides a mobile terminal comprising: a transceiver to send and receive signals via a mobile communication network; an output unit to provide audible, visual, and/or tactile outputs upon receiving an incoming communication; and a processor cooperating with the transceiver and the output unit to perform the steps of, receiving a request to perform a phone location search feature, the request being included within the incoming communication, and providing an audible output such that the location of the mobile terminal can be determined by the user upon receiving the request to perform the phone location search feature.

Here, the request may have originated from a wireless communication device or from a landline communication device. The request to perform the phone location search feature may be an identifier inserted into a phone number of the mobile terminal that receives the incoming communication. The identifier may be provided by a key input or a menu selection from a user of the wireless communication device or the landline communication device. The audible output may be provided even if the mobile terminal is in a visual output only mode or in a tactile output only mode. The audible output may be provided through a speaker device, the visual output is provided through a display device and/or a light emitting device, and the tactile output is provided through a vibration device. If the incoming communication does not contain the request to perform the phone location search feature, the output unit may provide audible, visual, and/or tactile outputs according to its set output mode.

As so far described, the system and method for controlling a receiving mode of a mobile terminal has such an advantage that because a certain identifier is added to the phone number of the mobile terminal and then transmitted, that allows accurate detection of the position of the mobile terminal.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A system for controlling a receiving mode of a mobile terminal comprising:
a transmission terminal for receiving a phone number and an identifier and outputting a transmission call based on the phone call and the identifier;
a base station for outputting a call event based on the phone number and the identifier detected from the outputted transmission call; and
a receiving terminal for executing a predetermined receiving mode according to the outputted call event.

2. The system of claim 1, wherein the transmission terminal is one of a mobile terminal for wireless communication or a fixed line phone for landline communication.

3. The system of claim 2, further comprising: a phone exchange for transmitting a transmission call outputted from the fixed line phone to the base station.

4. The system of claim 1, wherein the identifier is one of a number or a symbol.

5. The system of claim 1, wherein the call event is one of a general call event or a search call event.

6. The system of claim 5, wherein the search call event is added as an option to the general call event.

7. The system of claim 6, wherein the option is a command or a service option (SO).

8. The system of claim 1, wherein the predetermined receiving mode is one of a sound mode, a vibration mode and a mute mode when the call event is a general call event.

9. The system of claim 1, wherein the predetermined receiving mode is a sound mode when the call event is a search call event.

10. A mobile terminal for controlling a receiving mode, the mobile terminal comprising:
a controller for generating transmission call based on a phone number and an identifier inputted by user; and
a transmitting unit for transmitting the generated transmission call.

11. The terminal of claim 10, wherein the identifier is one of a number or a symbol.

12. A mobile terminal for controlling a receiving mode, the mobile terminal comprising:
a receiving unit for receiving a call event outputted from a base station; and
a controller for executing a predetermined receiving mode according to the received call event.

13. The terminal of claim 12, wherein the call event is one of a general call event or a search call event.

14. The terminal of claim 13, wherein the search call event is added as an option to the general call event.

15. The terminal of claim 14, wherein the option is a command or a service option (SO).

16. The terminal of claim 12, wherein the predetermined receiving mode is one of a sound mode, a vibration mode and a mute mode when the call event is a general call event.

17. A method for controlling a receiving mode of a mobile terminal comprising:
receiving a phone number and an identifier and transmitting a transmission call based on the phone number and the identifier;
detecting the phone number and the identifier from the transmitted transmission call;
generating a call event according to the detection result;
checking whether the generated call event is a search call event; and
executing a pre-set receiving mode according to the checking result.

18. The method of claim 17, wherein the transmission call is transmitted to one of a mobile terminal for wireless communication and a fixed line phone for landline communication.

19. The method of claim 17, wherein the identifier is one of a number or a symbol.

20. The method of claim 17, wherein the call event is one of a general call event or a search call event.

21. The method of claim 20, wherein the search call event is added as an option to the general call event.

22. The method of claim 21, wherein the option is a command or a service option (SO).

23. The method of claim 17, wherein the predetermined receiving mode is a sound mode.

24. A mobile terminal comprising:
a transceiver to send and receive signals via a mobile communication network;
an output unit to provide audible, visual, and/or tactile outputs upon receiving an incoming communication; and
a processor cooperating with the transceiver and the output unit to perform the steps of,
receiving a request to perform a phone location search feature, the request being included within the incoming communication, and
providing an audible output such that the location of the mobile terminal can be determined by the user upon receiving the request to perform the phone location search feature.

25. The mobile terminal of claim 24, wherein the request originated from a wireless communication device or from a landline communication device.

26. The mobile terminal of claim 24, wherein the request to perform the phone location search feature is an identifier inserted into a phone number of the mobile terminal that receives the incoming communication.

27. The mobile terminal of claim 26, wherein the identifier is provided by a key input or a menu selection from a user of the wireless communication device or the landline communication device.

28. The mobile terminal of claim 24, wherein the audible output is provided even if the mobile terminal is in a visual output only mode or in a tactile output only mode.

29. The mobile terminal of claim 24, wherein the audible output is provided through a speaker device, the visual output is provided through a display device and/or a light emitting device, and the tactile output is provided through a vibration device.

30. The mobile terminal of claim 24, wherein if the incoming communication does not contain the request to perform the phone location search feature, the output unit provides audible, visual, and/or tactile outputs according to its set output mode.
